(19) United States
(12) Patent Application Publication
(10) Pub. No.: US 2004/0165302 A1
(43) Pub. Date: Aug. 26, 2004

(54) Structure of a multi-purpose thump-like hard disk device

(76) Inventor: William Lu, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/369,733

(22) Filed: Feb. 21, 2003

(51) Int. Cl. G11B 5/00; G11B 5/02

(52) U.S. Cl. 360/55; 360/1

(57) ABSTRACT

The present invention relates to an improved structure of a multi-purpose thumb-like hard disk device especially one very small and easy to carry along. The present invention mainly consists of a digital music playing module, a battery stand and a laser source assembled in a thumb-like shell designed with recording, playing, information transmission and laser operating buttons as well as indicating lights for operation of different functions. The present invention therefore provides a very convenient small sized MP3, recorder, laser pen drive and surface file transmission device.

### TECHNICAL RANGE

The present invention relates to an improved structure of a multi-purpose thumb-like hard disk device especially one very small and easy to carry along.

### INVENTION BACKGROUND

Commonly used MP3 players can only play music files obtained from the computer but do not have recording functions. Another commonly used thumb-like hard disk device also obtains its information from the file document of computers and can be carried along for easy saving and transmission of information. In order to join the advantages of the above-mentioned devices, a thumb-like hard disk MP3 player has been developed and, with the use of an improved transferring interface, transmission process is much facilitated and the USB interface can be directly connected to the playing module at any time.

Although volume and weight of the thumb-like hard disk is reduced to that on a lighter, the battery stand still has to be removable. This can cause much inconvenience because the battery stand is bigger than the thumb-like hard disk device and has to be detached when the computer is connected to the USB connector. Another drawback is that the device is only equipped with a playing function and not a recording one.

Hence, in order to obviate the above drawbacks, the object of the present invention of an improved multi-purpose thumb-like hard disk device is to provide a small and light, easy to carry along device equipped with a playing as well as recording functions with laser pen drive and light.

### SUMMARY OF INVENTION

The present invention relates to an improved structure of a multi-purpose thumb-like hard disk device consisting of a digital music playing module, a battery stand and a laser source all assembled to form a thumb-like shell designed with recording, playing, file transmission and laser buttons as well as indicating lights for operation of different functions.

The present invention relates to an improved structure of a multi-purpose thumb-like hard disk device wherein the digital music module can play MP3 music as well as record and play just as any other cassette recorders.

The present invention relates to an improved structure of a multi-purpose thumb-like hard disk device wherein the battery stand is directly designed in the thumb-like shell and can be changed at the back cover without having to detach the battery when it is inserted to computers.

The present invention relates to an improved structure of a multi-purpose thumb-like hard disk device wherein the laser source is designed at the rear end of the thumb-like shell next to the earphone inserting hole for laser pen drive or lighting.

The present invention relates to an improved structure of a multi-purpose thumb-like hard disk device wherein the hat body found at the front edge of the thumb-like shell has to be taken off before inserting the computer to USB connector. The hat body is, however, very light and small and can act as a protective cover to maintain quality of USB.

The present invention relates to an improved structure of a multi-purpose thumb-like hard disk device wherein the operating buttons and indicating lights as well as the rear hanging hole are found in the thumb-like shell and easy to operate.

### DESCRIPTON OF DRAWINGS

FIG. 1 shows a plan of a commonly used thumb-like hard disk device.

FIG. 2 shows an outer structure of the present invention.

FIG. 3 shows a rear structure of the present invention.

FIG. 4 shows a view of the present invention without the hat cover.

FIG. 5 shows a view of the inner structure of the present invention.

### NUMERICALS

11—MP3 thumb-like hard disk

11—battery stand

12—playing module

20—multi purpose thumb-like hard disk

21—thumb-like shell body

22—hat body

23—laser LED source

24—earphone inserting hole

25—hanging hole

26—record receiving hole

27—LED power button

28—recording button

29—MP3 status indicating light

30—recording status indicating light

31—file transmission status indicating light

32—hoice operating button

33—volume and repeat operating button

34—double cover

35—USB connector

36—battery

### MODE FOR CARRYING OUT INVENTION

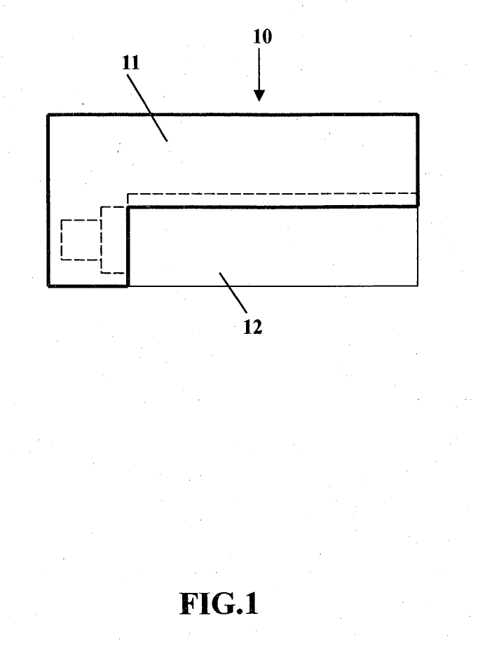

With reference to FIG. 1 showing a plan of the commonly used thumb-like hard disk device, the invention mainly consists of a battery stand 11 and playing module 12 assembled to form a MP3 thumb-like hard disk device 10 and have to be mounted before being taken along. Further, the battery stand 11 has to be removed during file transmission and though the playing module 12 is light and small like a lighter, its use is only limited when file transmission is not carried along. Since the functions are only limited to the music file and file transmission of the computer, this commonly used invention is not very convenient.

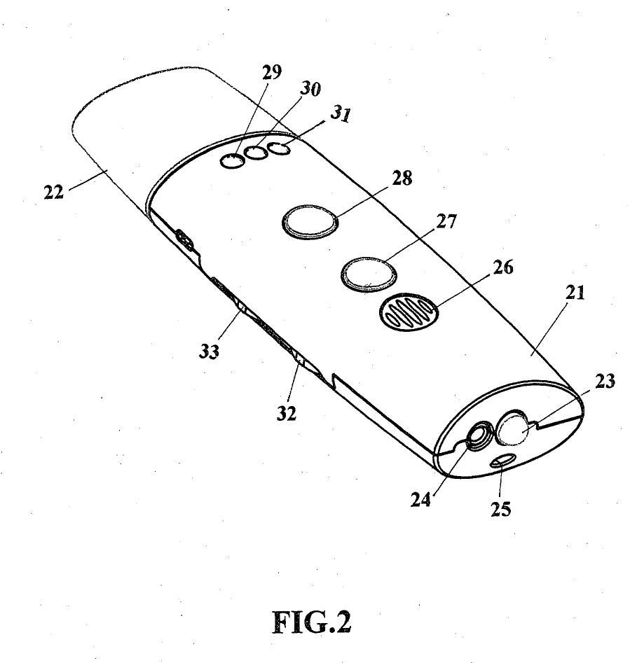

With reference to FIG. 2 showing an outer structure of the present invention, the thumb-like shell body 21 is assembled to a hat body 22 and designed with a laser LED source 23, earphone inserting hole 24 and hanging hole 25 at the rear edge and a record receiving hole 26, LED power button 27, recording button 28, MP3 status indicating light 29, recording status light 30 and file transmission status indicating light 31 at the front edge. Further, a choice operating button 32 and volume and repeat operating button 33 are found at the outer side of the device.

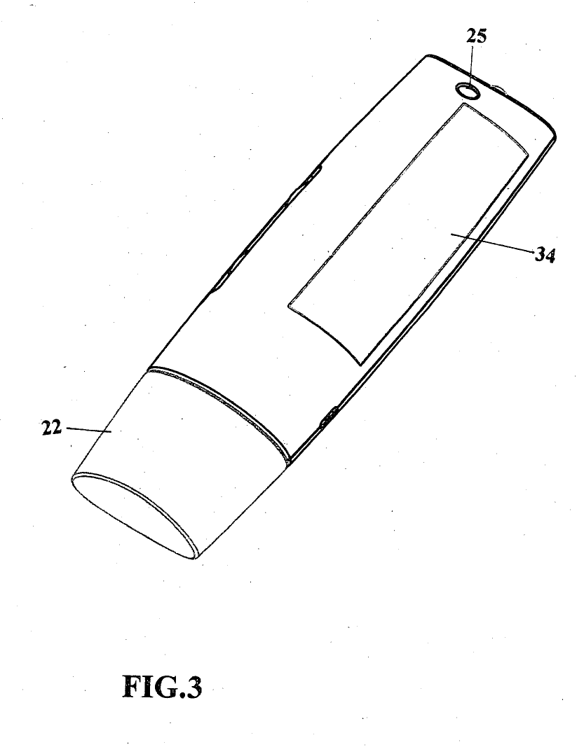

With reference to FIG. 3 showing a rear structure of the present invention, a double cover 34 is designed for changing of batteries.

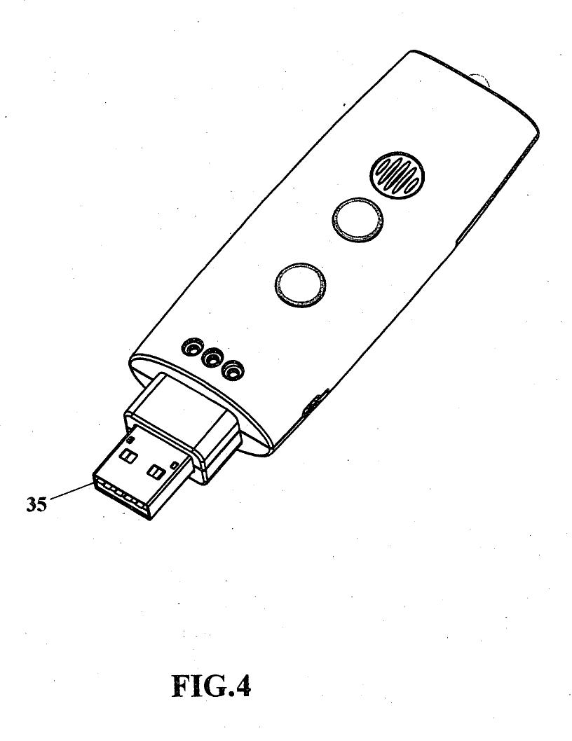

With reference to FIG. 4 showing a view of the present invention without the hat cover, USB connector 35 is used for connection of USB and computer for direct transmission of file.

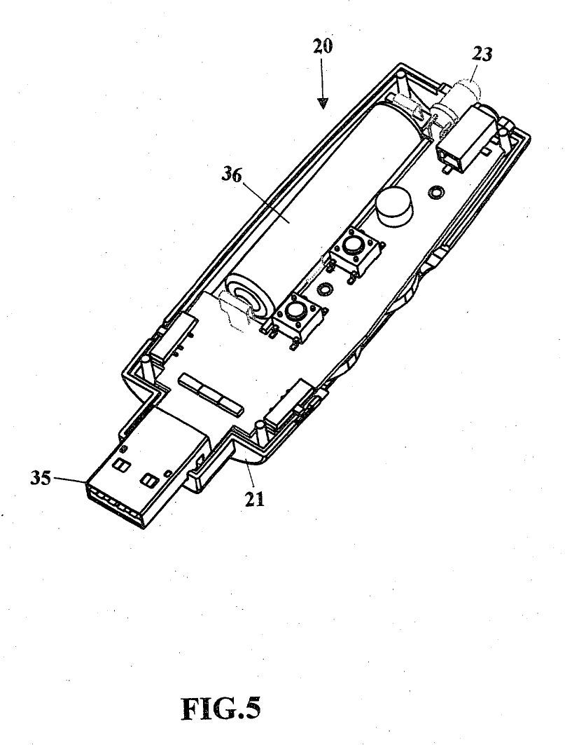

With reference to FIG. 5 showing a view of the inner structure of the present invention, the multi-purpose thumb-like hard disk device 20 join battery 36 and laser LED source 23 to playing module of digital music and secures the assembly in an elegant thumb-like shell body 21. Hence, the present invention provides a very convenient small sized MP3, recorder, laser pen drive and surface file transmission device.

1. An improved structure of a multi-purpose thumb-like hard disk device mainly assembling a digital music playing module, a battery stand and a laser source all assembled to form a thumb-like shell designed with recording, playing, file transmission and laser buttons as well as indicating lights for operation of different function, wherein characterized

2. As mentioned in claim 1 of an improved structure of a multi-purpose thumb-like hard disk device wherein a thumb-like shell body is assembled to a hat body and designed with a laser LED source, earphone inserting hole and a hanging hole at the rear edge and a record receiving hole, LED power button, recording button, MP3 status indicating light, recording status indicating light and file transmission status transmission indicating light at the front edge; Further, a choice operating button and volume and repeat operating button are found at the outer side of the device.

3. As mentioned in claim 1 of an improved structure of a multi-purpose thumb-like hard disk device wherein the double cover found at the rear of the thumb-like shell body is used for changing batteries.

4. As mentioned in claim 1 of an improved structure of a multi-purpose thumb-like hard disk device wherein the hat body is very small and light and can act as a protective cover to maintain quality of USB.
